(19) United States
(12) Patent Application Publication
(10) Pub. No.: US 2007/0080913 A1
(43) Pub. Date: Apr. 12, 2007

(54) Display device and testing method for display device

(75) Inventors: Tae-Hyeong Park, Yongin-si (KR); Cheol-Min Kim, Seoul (KR); Il-Gon Kim, Seoul (KR); Chul-Ho Kim, Seoul (KR); Gi-Chang Lee, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/545,961

(22) Filed: Oct. 10, 2006

(30) Foreign Application Priority Data
Oct. 12, 2005 (KR) 10-2005-0095924

(51) Int. Cl. G09G 3/36

(52) U.S. Cl. 345/87

(57) ABSTRACT

The present invention relates to a display device and a method of testing a display device. A display device according to an exemplary embodiment of the present invention includes: a gate driver for generating gate signals and applying the gate signals to switching elements; a precharge circuit for applying a predetermined voltage to the pixels to precharge the pixels; and a pad portion including a plurality of inspection pads for applying test signals to the gate driver and the precharge circuit. Accordingly, test signals are applied through pads using the gate driver and the precharge circuit, which makes it possible to check whether the two driving circuits normally operate and to detect defects, such as the disconnection or short-circuit of the signal lines, before a module process. Thus, it is possible to reduce manufacturing time and cost.

### CROSS-REFERENCE TO RELATED APPLICATION

This application claims priority to and the benefit of Korean Patent Application No. 10-2005-0095924 filed in the Korean Intellectual Property Office on Oct. 12, 2005, the entire contents of which are incorporated herein by reference.

### BACKGROUND OF THE INVENTION

(a) Field of the Invention

The present invention relates to a display device and a method of testing the display device.

(b) Description of the Related Art

In recent years, a flat panel display, such as an OLED (organic light emitting diode display), a plasma display panel (PDP), and a liquid crystal display (LCD), has been actively developed as a substitute of a big and heavy CRT (cathode ray tube).

The PDP is a device for displaying characters or images using plasma generated by a gas discharge, and the OLED displays characters or images using a specific organic material or electroluminescence of high molecules. A liquid crystal display displays a desired image by applying an electric field to a liquid crystal layer interposed between two display panels and adjusting the intensity of the electric field to modulate the transmittance of light passing through the liquid crystal layer.

In such flat panel displays, for example, the liquid crystal display and the OLED include a display panel that has pixels each including a switching element and display signal lines, a gate driving IC that supplies gate signals to gate lines of the display signal lines to turn on/off the switching elements of the pixels, a gray voltage generator that generates a plurality of gray voltages, a data driving IC that selects a voltage corresponding to image data from the gray voltages as a data voltage and applies the data voltage to data lines of the display signal lines, and a signal controller for controlling these components.

In a display device, a disconnection or short circuit of the display signal lines or defects in the pixels are found in advance through predetermined tests during a process of manufacturing the display device. The tests include, for example, an array test, a VI (visual inspection) test, a gross test, and a module test.

The array test is a test for examining whether display signal lines are broken by applying a predetermined voltage before separation of cells and determining whether an output voltage is detected, and the VI test is a test for examining whether display signal lines are broken by applying a predetermined voltage after the separation of cells, by evaluation with the naked eye. The gross test is a test for examining picture quality and disconnection of display signal lines through the display state of a picture by combining an upper panel with a lower panel and applying the same voltage as an actual driving voltage before mounting a driving circuit, and the module test is a test for finally examining whether the driving circuit normally operates after it is mounted.

The signal controller and the gray voltage generator are disposed on a PCB (printed circuit board) outside the display panel. The driving IC is mounted on a FPC (flexible printed circuit) substrate between the PCB and the display panel. In general, two PCB are provided. In this case, they are disposed at the left and above the display panel, respectively, and the left one is called a gate PCB and the other is called a data PCB. The gate driving IC is positioned between the gate PCB and the display panel, and the data driving IC is positioned between the data PCB and the display panel. The gate driving IC and the data driving IC receive signals from the corresponding PCBs.

However, the gate driving IC and the data driving IC may be directly mounted on the display panel without the gate PCB and the data PCB [COG (chip on glass) type]. Most driving circuits, including a signal controller and a power generating circuit, may also be mounted on the display panel [SOG (system on glass) type].

In a display device formed in the SOG type, it is difficult to apply a test signal due to complexity of the driving signal because almost all the circuits are mounted on the display panel. For this reason, after a process of attaching an FPC film for applying a test signal, a module process is performed and a control signal and a voltage are applied to all of the mounted driving circuits, to make it possible to check whether disconnection or defects in pixels occur. Accordingly, defective products, which may be isolated during the VI test or the gross test of the COG type, can be checked only after the FPC is mounted and a module test is performed for the SOG type. As a result, time and cost required for the module process increases.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a test circuit of a display device and a method of testing a display device that is capable of detecting defects before a FPC is mounted.

According to an exemplary embodiment of the present invention, a display device includes: a display panel having a plurality of pixels each including a switching element, gate lines, and data lines, the gate lines and the data lines being connected with the pixels; a gate driver for generating gate signals and applying the gate signals to the switching elements; a precharge circuit for applying a predetermined voltage to the pixels to precharge the pixels; and a pad portion including a plurality of inspection pads for applying test signals to the gate driver and the precharge circuit.

In this embodiment, the precharge circuit may include transmission gate portions connected with the data lines.

A common voltage may be applied to the pixels through one of the pads.

The gate driver may include a plurality of stages that are connected in a line and generate the gate signals, and the display device may further include a signal controller for controlling the gate driver and the precharge circuit.

The gate driver, the precharge circuit, and the signal controller may be mounted on the display panel.

The precharge circuit may include a first circuit that includes transmission gate portions connected with odd-numbered data lines, and a second circuit that includes transmission gate portions connected with even-numbered data lines.

A common voltage may be applied to the pixels through one of the pads.

The gate driver may include a plurality of stages that are connected in a line and generate the gate signals.

The display device may further include a signal controller for controlling the gate driver and the precharge circuit, and the gate driver, the precharge circuit, and the signal controller may be mounted on the display panel.

According to another exemplary embodiment of the present invention, a method of testing a display device includes: forming a display panel having pixels and first and second signal lines connected with the pixels; sequentially mounting, on the display panel, a gate driver for applying gate signals to the first and second signal lines and a precharge circuit for applying a predetermined voltage to the first and second signal lines; forming, on the display panel, a pad portion connected with the gate driver and the precharge circuit; and applying test signals through the pad portion.

In this embodiment, the precharge circuit may include transmission gate portions connected with the data lines.

The applying of a test signal through the pad portion may include applying a common voltage to the pixels through one of the pads.

The gate driver may include a plurality of stages that are connected in a line and generate the gate signals.

The precharge circuit may include a first circuit that includes transmission gate portions connected with odd-numbered data lines, and a second circuit that includes transmission gate portions connected with even-numbered data lines.

The applying of a test signal through the pad portion may include applying a common voltage to the pixels through one of the pads.

The gate driver may include a plurality of stages that are connected in a line and generate the gate signals.

### BRIEF DESCRIPTION OF THE DRAWINGS

The accompanying drawings briefly described below illustrate exemplary embodiments of the present invention, and together with the description, serve to explain the principles of the present invention.

FIG. 1 is a block diagram of a liquid crystal display according to an exemplary embodiment of the present invention.

FIG. 2 is an equivalent circuit diagram of a pixel of a liquid crystal display according to an exemplary embodiment of the present invention.

FIG. 3 is a schematic layout view of a liquid crystal display according to an exemplary embodiment of the present invention.

FIG. 4 is a block diagram of a gate driver shown in FIG. 3.

FIG. 5 is a block diagram of a precharge circuit shown in FIG. 3.

FIG. 6 is an enlarged view of an inspection pad portion shown in FIG. 3.

FIG. 7 is a schematic layout view of a liquid crystal display according to another exemplary embodiment of the present invention.

FIG. 8 is a block diagram of a precharge circuit shown in FIG. 7.

### DETAILED DESCRIPTION OF THE EMBODIMENTS

The present invention will be described more fully hereinafter with reference to the accompanying drawings, in which preferred embodiments of the invention are shown.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

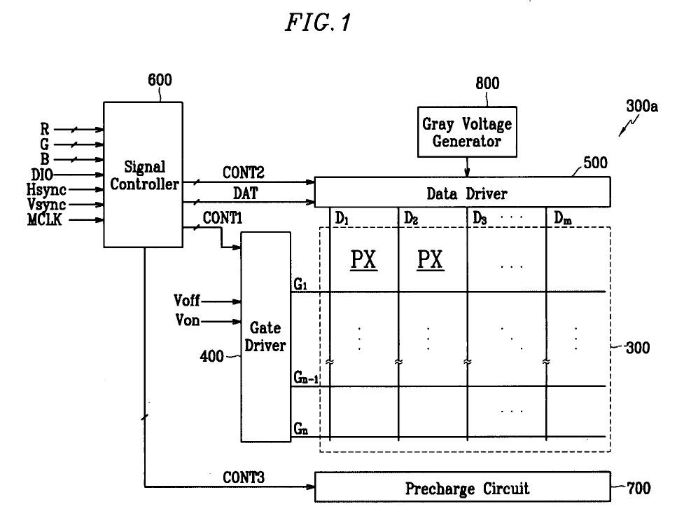

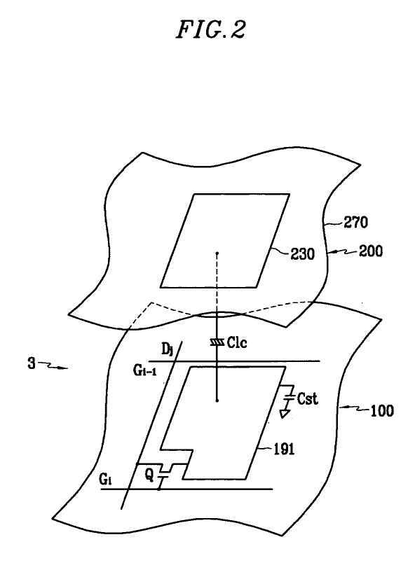

First, a display device according to an exemplary embodiment of the present invention will be described in detail below, referring to FIGS. 1 and 2, and a liquid crystal display will be described as an example.

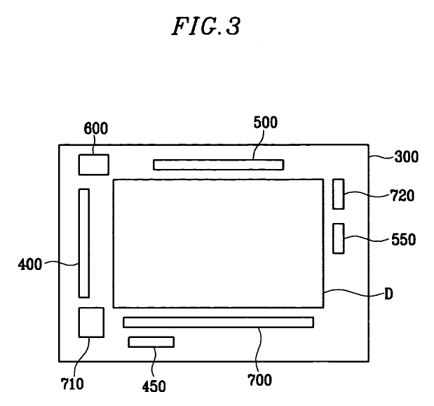

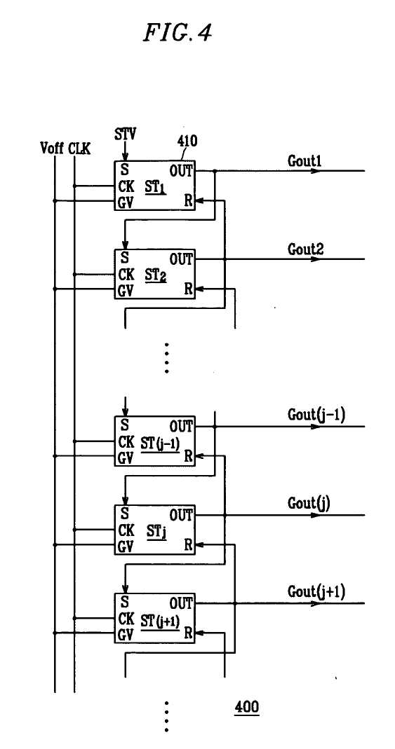

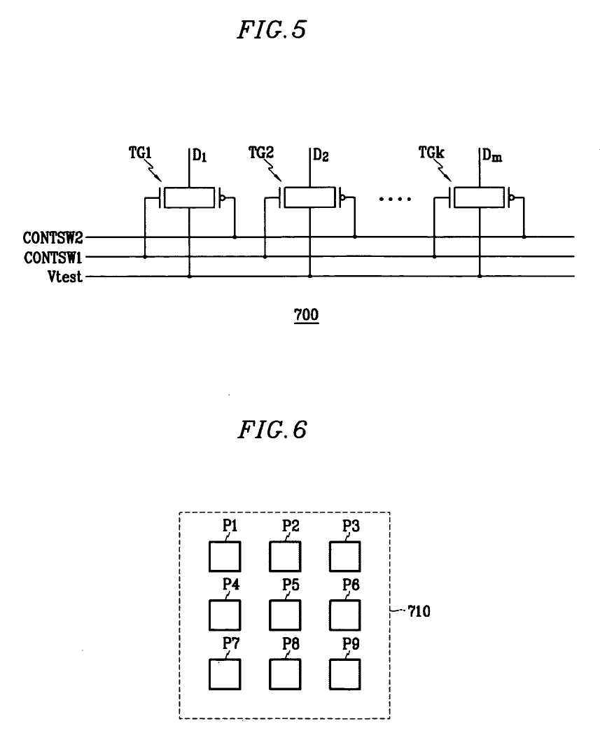

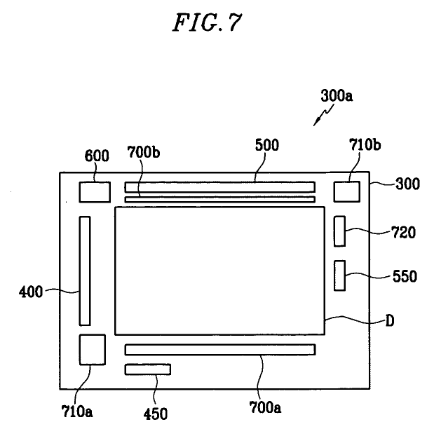

FIG. 1 is a block diagram of a liquid crystal display according to an exemplary embodiment of the present invention, and FIG. 2 is an equivalent circuit diagram of a pixel of a liquid crystal display according to an exemplary embodiment of the present invention. FIG. 3 is a schematic layout view of a liquid crystal display according to an exemplary embodiment of the present invention, and FIGS. 4 to 6 are block diagrams illustrating a gate driver, a precharge circuit, and an inspection pad portion shown in FIG. 3, respectively.

As shown in FIG. 1, a liquid crystal display according to an exemplary embodiment of the present invention includes a liquid crystal panel assembly 300, a gate driver 400, a data driver 500, a precharge circuit 700, a gray voltage generator 800 connected with the data driver 500, and a signal controller 600 controlling these components. The gate driver 400, the data driver 500, and the precharge circuit 700 are connected to the liquid crystal panel assembly 300.

Further, as shown in FIG. 3, the gate driver 400, the data driver 500, the signal controller 600, the precharge circuit 700, level shifters 450 and 550, a DC/DC converter 720, and an inspection pad portion 710 are mounted on the liquid crystal panel assembly 300.

The liquid crystal panel assembly 300, in the equivalent circuit, includes a plurality of signal lines G₁ to Gₙ and D₁ to Dₘ, and a plurality of pixels PX that are connected with the signal lines and are arranged substantially in a matrix. In the configuration of FIG. 2, the liquid crystal panel assembly 300 includes lower and upper panels 100 and 200 facing each other, and a liquid crystal layer 3 interposed between the panels 100 and 200.

The signal lines G₁ to Gₙ and D₁ to Dₘ are composed of a plurality of gate lines G₁ to Gₙ for transmitting gate signals (also called “scanning signals”), and a plurality of data lines D₁ to Dₘ for transmitting data signals. The gate lines G₁ to Gₙ extend substantially in a row direction and are substantially parallel with each other. The data lines D₁ to Dₘ extend substantially in a column direction and are substantially parallel with each other.

Each of the pixels PX, for example a pixel PX connected to an i-th (i=1, 2, . . . , n) gate line Gᵢ and a j-th (=1, 2, . . . , m) data line Dj, includes a switching element Q connected to signal lines Gᵢ and Dⱼ, and a liquid crystal capacitor Clc and a storage capacitor Cst that are connected to the switching element Q. If necessary, the storage capacitor Cst may be omitted.

The switching element Q is a three-terminal element, such as a thin film transistor, that is provided on the lower panel 100. The switching element Q has a control terminal connected to the gate line Gᵢ, an input terminal connected to the data line Dⱼ, and an output terminal connected to both the liquid crystal capacitor Clc and the storage capacitor Cst.

The liquid crystal capacitor Clc has a pixel electrode 191 of the lower panel 100 and a common electrode 270 of the upper panel 200 as two terminals, and the liquid crystal layer 3 between the two electrodes 191 and 270 as a dielectric material. The pixel electrode 191 is connected to the switching element Q, and the common electrode 270 is formed on the entire surface of the upper panel 200. A common voltage Vcom is applied to the common electrode 270. Unlike the configuration shown in FIG. 2, the common electrode 270 may be formed on the lower panel 100. In this case, at least one of the two electrodes 191 and 270 may be formed in a linear or rod shape.

The storage capacitor Cst, serving as an auxiliary member of the liquid crystal capacitor Clc, is formed of a laminated structure of a separate signal line (not shown) that is provided on the lower panel 100, the pixel electrode 191 is formed thereon, and an insulator is interposed therebetween. A predetermined voltage, such as the common voltage Vcom, is applied to the separate signal line. However, the storage capacitor Cst may be formed in a laminated structure of the pixel electrode 191, a previous gate line, and an insulator interposed therebetween.

Meanwhile, each of the pixels PX specifically displays one of the primary colors (spatial division), or each of the pixels PX alternately displays the primary colors over time (temporal division) to display a color so that a desired color is displayed by a spatial and temporal summation of the primary colors. Three colors red, green, and blue may be exemplified as examples of the primary colors. FIG. 2 shows an example of the spatial division in which each of the pixels PX includes a color filter 230 for displaying one of the primary colors in a region of the upper panel 200 corresponding to the pixel electrode 191. Unlike the configuration shown in FIG. 2, the color filter 230 may be formed on or beneath the pixel electrode 191 of the lower panel 100.

At least one polarizer (not shown) for polarizing light is attached to the outer surface of the liquid crystal panel assembly 300.

The gray voltage generator 800 generates two gray voltage groups (or reference gray voltage groups) relating to the transmittance of the pixel PX. One of the two gray voltage groups has a positive value with respect to the common voltage Vcom, and the other gray voltage group has a negative value.

The gate driver 400 is connected to the gate lines G₁, to Gₙ of the liquid crystal panel assembly 300, and applies G₁ to Gₙ gate signals that are formed of a combination of a gate-on voltage Von and a gate-off voltage Voff to the gate lines.

As shown in FIG. 4, the gate driver 400 functions as a shift register including a plurality of stages 410 that are arranged in a line and are connected with the gate lines G₁ to Gₙ, and is supplied with a scanning start signal STV, a clock signal CLK, and a gate-off voltage Voff. Alternatively, a plurality of clock signals CLK may be input.

Each stage 410 has a set terminal S, a gate voltage terminal GV, a clock terminal CK, a reset terminal R, and an output terminal OUT.

In each stage, for example, a gate output of a previous stage ST(j−1), i.e., a previous-stage gate output Gout(j−1) is input to the set terminal S of a j-th stage STj. A gate output of a latter stage ST(j+1), i.e., a latter-stage gate output Gout(j+1), is input to the reset terminal R of the j-th stage STj. A clock signal CLK is input to the clock terminal CK, and a gate-off voltage Voff is input to the gate voltage terminal GV.

However, instead of a previous carry output, a scanning start signal STV is input to a first stage ST1 of the shift register 400.

According to this configuration, for example, the j-th stage STj generates a gate signal Gout(j) on the basis of the previous-stage and latter-stage gate signals Gout(J−1) and Gout(j+1) and in synchronization with the clock signal CLK.

The data driver 500 is connected to the data lines D₁ to Dₘ of the liquid crystal panel assembly 300. In addition, the data driver 500 selects a gray voltage from the gray voltage generator 800 and applies the selected gray voltage to the data lines D₁ to Dₘ as a data signal. However, when the gray voltage generator 800 does not provide gray voltages for all gray-scales, but provides only a predetermined number of reference gray voltages, the data driver 500 generates gray voltages for all the gray-scales by dividing the reference gray voltages, and selects a data signal among the gray voltages for all the gray-scales.

The precharge circuit 700 is disposed below the display area D. Alternatively, the precharge circuit 700 may be included in the data driver 500. The precharge circuit 700 applies a predetermined voltage to the pixels before a data voltage from the data driver 500 is applied thereto, thereby precharging the pixels, which makes it possible to shorten the total charging time. The precharge circuit 700 includes a plurality of transmission gates TG1 to TGm connected with the data lines D1 to Dm.

The transmission gates TG1 to TGm, as known, are composed of two different types of transistors, for example N-type transistors and P-type transistors. A predetermined voltage is applied to input terminals of each of the transmission gates TG1 to TGm. Switching control signals CONTSW1 and CONTSW2 are applied to two control terminals, and output terminals are connected with the data lines D1-Dm. In this case, a testing voltage Vtest may be applied during testing.

The inspection pad portion 710 includes a plurality of pads P1 to P9. As an example, nine pads are shown in the drawing. Testing signals required to test the gate driver 400 and the precharge circuit 700 are applied through each of the pads P1 to P9.

The testing signals, for example a testing voltage Vtest and the switching control signals CONTSW1 and CONTSW2, are applied to the precharge circuit 700 through the pads P1 to P3. The gate-off voltage Voff, the clock signal CLK, and the scanning start signal STV are applied to the precharging circuit 700 through the pads P4 to P6, and the common voltage Vcom and a ground voltage are applied through the other pads P7 to P9.

The DC/DC converter 720 and the level shifters 450 and 550 form a power generating circuit, and provide a voltage required for driving by raising or lowering a predetermined voltage. The DC/DC converter 720 raises or drops a voltage from the outside to a predetermined level, and the level shifters 450 and 500 are supplied with a voltage from the DC/DC converter 720 and provide a voltage required for the gate driver 400 and the data driver 500, respectively.

The signal controller 600 controls the gate driver 400, the data driver 500, and the precharge circuit 700.

Each of the drivers 400, 500, 600, 700, and 800 may be mounted on a flexible printed circuit film (not shown) and attached to the liquid crystal panel assembly 300 in the form of a TCP (tape carrier package), or it may be mounted on an independent PCB (printed circuit board; not shown). Alternatively, the drivers 400, 500, 600, 700, and 800 may be integrated into the liquid crystal panel assembly 300 together with the signal lines G₁, to Gₙ and D₁, to Dₘ and the switching elements Q such as TFTs.

The operation of the liquid crystal display will be described in detail below.

The signal controller 600 receives input image signals R, G, and B from an external graphics controller (not shown), and input control signals for controlling the display of the input image signals R, G, and B. The input control signals include, for example, a vertical synchronization signal Vsync, a horizontal synchronization signal Hsync, a main clock signal MCLK, and a data enable signal DE.

The signal controller 600 appropriately processes the input image signals R, G, and B on the basis of the input image signals R, G, and B and the input control signals so as to be suitable for the operational conditions of the liquid crystal panel assembly 300, and generates gate control signals CONT1, data control signals CONT2, switching control signals CONT 3, and the like. Then, the signal controller 600 transmits the gate control signals CONT1 to the gate driver 400, and transmits the data control signals CONT2 and the processed image signals DAT to the data driver 500, and the switching control signals CONT3 to the precharge circuit 700.

The gate control signal CONT1 includes a scanning start signal STV for instructing the start of scanning and at least one clock signal for controlling the output cycle of the gate-on voltage Von. In addition, the gate control signal CONT1 may further include an output enable signal (OE) for defining the duration of the gate-on voltage Von.

The data control signal CONT2 includes a horizontal synchronization start signal STH for indicating the start of transmitting image data to a row (group) of pixels PX, a data clock signal HCLK, and a load signal LOAD for causing the data signals to be applied to the data lines D₁ to Dₘ. In addition, the data control signal CONT2 may further include an inversion signal RVS for inverting the voltage polarity of the data signal with respect to the common voltage Vcom (hereinafter, “the voltage polarity of the data signal with respect to the common voltage” is referred to as “the polarity of the data signal”).

The switching control signal CONT3 includes a plurality of signals with opposite phases.

The precharge circuit 700 applies a constant voltage to the data lines D₁ to Dₘ according to the switching control signal CONT3 from the signal controller 600 and charges the pixels.

On the basis of the data control signal CONT2 from the signal controller 600, the data driver 500 receives the digital image signals DAT for a row (group) of pixels PX, selects gray voltages corresponding to the digital image signals DAT, converts the digital image signals DAT into analog data signals, and applies the analog data signals to the corresponding data lines D₁ to Dₘ.

The gate driver 400 applies the gate-on voltage Von to the gate lines G₁, to Gₙ on the basis of the gate control signal CONT1 from the signal controller 600 to turn on the switching elements Q connected to the gate lines G₁ to Gₙ. Accordingly, the data signals applied to the data lines D₁ to Dₘ are supplied to the corresponding pixels PX through the switching elements Q that are in an on state.

The difference between the voltage of the data signal applied to each pixel PX and the common voltage Vcom is represented as a voltage charged in the liquid crystal capacitor Clc, that is, a pixel voltage. Since the arrangement of the liquid crystal molecules is changed depending on the level of the pixel voltage, the polarization of light passing through the liquid crystal layer 3 is changed. The change of the polarization is represented as a change in transmittance by the polarizers attached to the display panel assembly 300.

The above-mentioned processes are repeatedly performed every one horizontal period (which is represented as “1H”, and is equal to one period of the horizontal synchronization signal Hsync and the data enable signal DE). In this way, the gate-on voltage Von is sequentially applied to all the gate lines G₁ to Gₙ and the data signals are applied to all the pixels PX, thereby displaying one frame an image.

The display of a previous frame is completed, and then the display of a next frame begins. Then, the inversion signal RVS applied to the data driver 500 is controlled so that the data signal applied to each pixel PX has the polarity opposite to that in the previous frame (“frame inversion”). In this case, even in one frame, the polarity of a data signal to be transmitted through one data line is changed (for example, row inversion and dot inversion) depending on the characteristic of the inversion signal RVS, or the polarities of data signals applied to one row of pixels may be different from each other (for example, column inversion and dot inversion).

Further, the testing according to the present invention is processed using the gate driver 400 and the precharge circuit 700, and a control signal and power required to operate the driving circuits 400 and 700 are provided through the pads P1 to P9.

As described above, the control signals CLK and STV and the voltage Voff for the gate driver 400 and the control signals CONTSW1 and CONTSW2 and the voltage Vtest for the operation of the precharge circuit 700 are applied through the pads P1 to P9.

Accordingly, it is determined whether gate driver 400 and the precharge circuit 700 normally operate.

When the gate driver 400 and the precharge circuit 700 normally operate, it is determined whether disconnections between the gate lines G1 to Gn and the data lines D1 to Dm as well as defectives in pixels PX occur by examining the screen.

As described above, it is possible to determine whether a module process of attaching an FPC can be performed or not by examining defectives beforehand, and thus time and cost can be reduced.

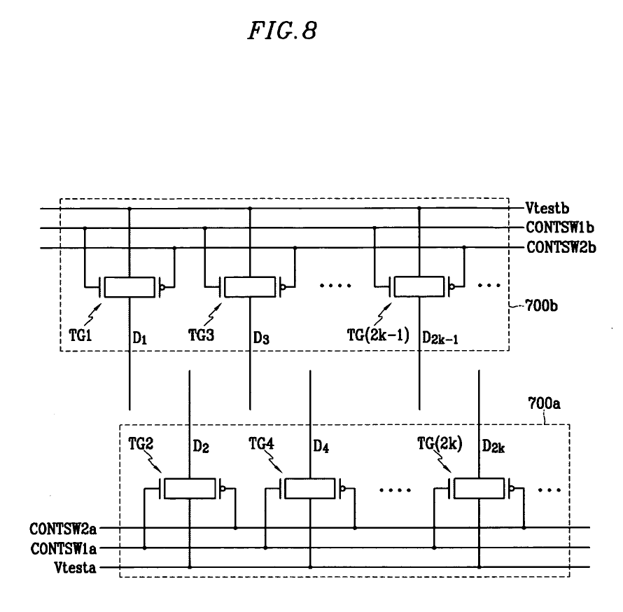

FIGS. 7 and 8 illustrate a test circuit according to another exemplary embodiment of the present invention. In this embodiment, components other than precharge circuits 700a and 700b and pad portions 710a and 710b are the same as those in the above-described embodiment, and thus a detailed description thereof will be omitted.

Unlike that shown in FIG. 3, a test circuit, specifically the precharge circuits 700a and 700b shown in FIG. 7, are disposed under and over a display area D. The pad portions 710a and 710b are disposed to apply test signals CONTSW1a, CONTSW2a, Vtesta, CONTSW1b, CONTSW2b, and Vtestb to the precharge circuits 700a and 700b.

The precharge circuits 700a and 700b include transmission gates, similar to the precharge circuit 700 shown in FIG. 3. However, transmission gates TG2, TG4, . . . , TG 2k of the precharge circuit 700a are connected with even-numbered data lines D₂, D₄, . . . , D₂ₖ, and transmission gates TG1, TG3, . . . , TG (2k−1) of the precharge circuit 700b are connected with odd-numbered data lines D₁, D₃, . . . , D₂ₖ₋₁.

According to the above-mentioned configuration, when the precharge circuits 700a and 700b are disposed under and over the display area D, respectively, and test signals are alternately applied to both the precharge circuits 700a and 700b, it is possible to determine whether the data lines D₁ to Dₘ are short-circuited, whether the two driving circuits 400 and 700 normally operate, and whether the signal lines G₁ to Gₙ and D₁ to Dₘ are broken.

As described above, when test signals are applied through the pads P1 to P9 using the gate driver 400 and the precharge circuit 700, it is possible to check whether the two driving circuits normally operate and to detect the disconnection or short-circuit of the signal lines before a FPC is attached. As a result, it is possible to reduce manufacturing time and cost.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device, comprising:
a display panel having a plurality of pixels each including a switching element, gate lines, and data lines, the gate lines and the data lines being connected with the pixels;
a gate driver for generating gate signals and applying the gate signals to the switching elements;
a precharge circuit for applying a predetermined voltage to the pixels to precharge the pixels; and
a pad portion including a plurality of inspection pads for applying test signals to the gate driver and the precharge circuit.

2. The display device of claim 1, wherein the precharge circuit includes transmission gate portions connected with the data lines.

3. The display device of claim 2, wherein a common voltage is applied to the pixels through one of the pads.

4. The display device of claim 3, wherein the gate driver includes a plurality of stages that are connected in a line and generate the gate signals.

5. The display device of claim 4, further comprising a signal controller for controlling the gate driver and the precharge circuit.

6. The display device of claim 5, wherein the gate driver, the precharge circuit, and the signal controller are mounted on the display panel.

7. The display device of claim 1, wherein the precharge circuit includes:
a first circuit that includes transmission gate portions connected with odd-numbered data lines; and
a second circuit that includes transmission gate portions connected with even-numbered data lines.

8. The display device of claim 7, wherein a common voltage is applied to the pixels through one of the pads.

9. The display device of claim 8, wherein the gate driver includes a plurality of stages that are connected in a line and generate the gate signals.

10. The display device of claim 9, further comprising a signal controller for controlling the gate driver and the precharge circuit.

11. The display device of claim 10, wherein the gate driver, the precharge circuit, and the signal controller are mounted on the display panel.

12. A method of testing a display device, comprising:
forming a display panel having pixels and first and second signal lines connected with the pixels;
sequentially mounting, on the display panel, a gate driver for applying gate signals to the first and second signal lines and a precharge circuit for applying a predetermined voltage to the first and second signal lines;
forming, on the display panel, a pad portion connected with the gate driver and the precharge circuit; and applying test signals through the pad portion.

13. The method of testing a display device of claim 12, wherein the precharge circuit includes transmission gate portions connected with the data lines.

14. The method of testing a display device of claim 13, wherein the applying of a test signal through the pad portion includes applying a common voltage to the pixels through one of the pads.

15. The method of testing a display device of claim 14, wherein the gate driver includes a plurality of stages that are connected in a line and generate the gate signals.

16. The method of testing a display device of claim 12, wherein the precharge circuit includes:
a first circuit that includes transmission gate portions connected with odd-numbered data lines; and
a second circuit that includes transmission gate portions connected with even-numbered data lines.

17. The method of testing a display device of claim 16, wherein the applying of a test signal through the pad portion includes applying a common voltage to the pixels through one of the pads.

18. The method of testing a display device of claim 17, wherein the gate driver includes a plurality of stages that are connected in a line and generate the gate signals.
